(19) United States
(12) Patent Application Publication
(10) Pub. No.: US 2007/0075450 A1
(43) Pub. Date: Apr. 5, 2007

(54) Parametrized material and performance properties based on virtual testing

(75) Inventors: Ashok D. Belegundu, University Park, PA (US); Subramaniam D. Rajan, Phoenix, AZ (US); James A. St. Ville, Phoenix, AZ (US)

Correspondence Address: NIXON & VANDERHYE, PC, 901 NORTH GLEBE ROAD, 11TH FLOOR, ARLINGTON, VA, 22203, US

(73) Assignee: Aztec IP Company LLC, Phoenix, AZ (US)

(21) Appl. No.: 11/542,647

(22) Filed: Oct. 4, 2006

Related U.S. Application Data
(60) Provisional application No. 60/722,985, filed on Oct. 4, 2005.

(51) Int. Cl. B29C 45/76

(52) U.S. Cl. 264/40.1; 221/24

(57) ABSTRACT

A method of generating a topology for a material includes parametrizing one or more material properties of the material using virtual testing and generating a topology for the material based on the parametrizing.

### CROSS-REFERENCE TO RELATED APPLICATION

This is application is a non-provisional of provisional application No. 60/722,985, filed Oct. 4, 2005, the contents of which are incorporated herein in their entirety.

### BACKGROUND AND SUMMARY

The design and manufacture of even the simplest product can be a very complex process. Some of the complexity arises from constraints that are imposed on the design and/or on the manufacturing process. For example, the function or use of the product general imposes certain constraints on the design. Aesthetics, cost, availability of materials, safety and numerous other considerations typically impose further constraints on the design.

Generally speaking, engineering design is concerned with the efficient and economical development, manufacturing and operation of a process, product or a system. In several engineering disciplines such as aerospace, chemical, mechanical, semiconductor, biomedical and civil, the design is a creative, albeit trial-and-error, process. With increasing emphasis on economical, efficient and optimized design, development of an automated or even semiautomated engineering design process can lead to improvements in cost, performance and/or manufacturing for a process, product or system, along with providing efficiencies and optimizations.

The systems and methods described in this application provide a semiautomated methodology that can lead to an economical, efficient and optimized design of a variety of engineering processes, products and systems. In particular, these systems and methods involve generating a topology for a material by paremetrizing one or more material properties of the material using virtual testing and generating a topology for the material based on the parametrizing.

### BRIEF DESCRIPTION OF THE DRAWINGS

FIG. 1A shows an example design flow diagram.

FIG. 1B shows an example evolution of an initial solid model to an uptated solid model following the design flow of FIG. 1A.

FIG. 1C is a schematic block diagram of a system for designing and manufacturing an object.

FIG. 2 schematically shows a topology optimization problem.

FIGS. 3(a) and 3(b) respectively show an example design domain and an example possible optimal topology.

FIGS. 4(a) and 4(b) show example virtual tests for parametizing certain material properties.

FIG. 5 provides a comparison between homogenized Young's modulus E from virtual testing with continuum based homogenization theory.

FIG. 6 provides a comparison between homogenized G₁₂ from virtual testing with continuum based homogenization theory.

FIGS. 7(a) and 7(b) respectively show an example initial domain and an example optimal topology.

FIG. 8 shows an example 3D finite element mesh for computing perties.

FIG. 9 shows an example 2D finite element mesh for computing transverse properties.

FIG. 10 shows the material properties of the constituents for the example virtual test discussed with reference to FIGS. 8 and 9.

FIG. 11 shows axial thermal conductivity versus volume fraction for the graphite/epoxy composite.

FIG. 12 shows transverse CTE values versus volume fraction for the graphite/epoxy composite.

FIG. 13 shows a flow diagram for another example process in which virtual testing may be used.

FIG. 14 is a generalized block diagram of computing equipment on which applications, modules, functions, etc. described in this application may be executed.

### DETAILED DESCRIPTION OF EXAMPLE EMBODIMENTS

The concepts and techniques described herein can be used in conjunction with a wide variety of design and manufacturing systems and processes and should not be viewed as being limited to any particular design and/or manufacturing system or process. The concepts and techniques are particularly useful when used in conjunction with so-called volumetrically controlled manufacturing (VCM) as described in U.S. Pat. No. 5,594,651 and Application Ser. No. 09/643,982, the contents of each of which are incorporated herein in their entirety. The VCM process can be used as a rapid prototyping method for composite materials and enables determination of the proper sequence and orientation of material property coefficients that must exist within a synthetic material to meet predefined tolerance specifications. The VCM process can be used for mechanical, thermal, electromagnetic, acoustic, and optic applications and is scalable to Macro, Micro, and Nano levels.

One of the advantages of the VCM methodology is that it enables design optimization of many variable raw materials in conjunction with each other, such as ceramics, resins and fiber. In addition to raw material types, the VCM methodology can also account for such variable parameters as volume, weight, density, and cost. Once the solutions to the model converge, the material property sequencing then translates directly into formats that can serve as inputs for manual, semi-automated, and automated machine control systems, to fabricate parts with near optimum material properties.

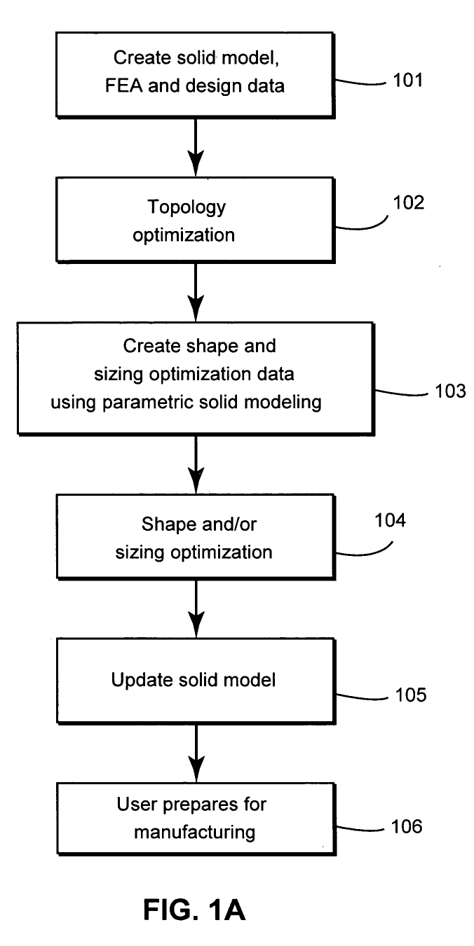

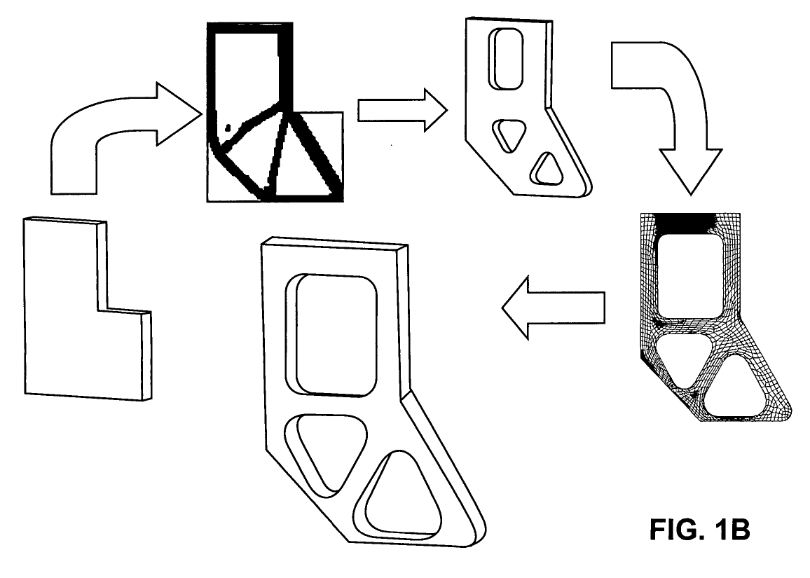

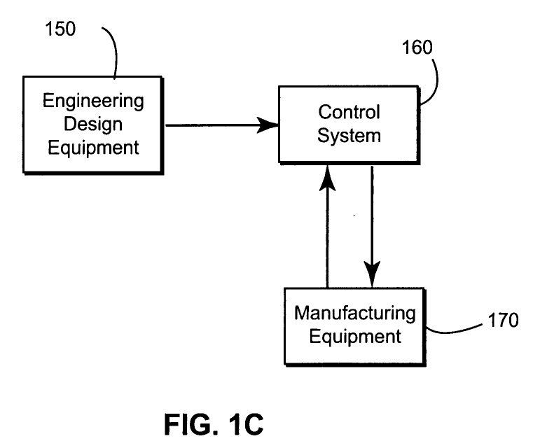

FIG. 1A shows by way of example without limitation a design flow in which the methods and systems described herein may be used. At step 101, an initial solid model is created using finite element analysis and design data. At step 102, the topology of the solid model is optimized and at step 103 shape and sizing optimization data is created using parametric solid modeling. At step 104, the shape and/or size of the model is optimized based on the information created at step 103 and at step 105 the solid model is updated. At step 106, the user prepares for manufacturing based on the updated solid model. This preparation may involve, among other things, generating the proper sequencing of control instructions for controlling suitable manufacturing equipment to thereby manufacture objects corresponding to the updated solid model.

FIG. 1B shows an example of the evolution of an initial solid model to an updated solid model via the example design flow of FIG. 1A.

FIG. 1C shows an example system for designing and manufacturing an object. The system includes engineering design equipment 150 which is used, for example, to implement the design flow shown in FIG. 1A. Design equipment 150 may include one or more computers running applications, modules, functions, etc. that permit the processes in the design flow to be implemented. These applications, modules and functions include, for example, computer-aided design applications and finite element analysis applications and may also includes applications, modules and functions based on the methodology discussed below. The one or more computers may be arranged in a networked or distributed architecture.

The output of design equipment 150 includes control instructions which are supplied to a control system 160. Control system 160 may be a processor-equipped device that uses the control instructions to generate control signals appropriate for controlling manufacturing equipment 170. These control signals may control manufacturing parameters such as temperature, pressure, supply of raw materials, mixtures of raw materials, and the like. Feedback from various sensors (e.g., temperature, pressure and the like) provided in manufacturing equipment 170 is supplied to control system 160 so that control system 160 can generate control signals to maintain temperature and pressure, for example, in certain ranges during the manufacturing process.

The control instructions are appropriately sequenced to allow the designed object to be manufactured according to the results of the design process. By way of example without limiation, the control instructions may control the properties of fibers (e.g., number, composition, size, etc.) laid into an epoxy to form a composite material. Additionally or alternatively, the control instructions may vary the properties of the epoxy to provide the object designed by the manufacturing process. By way of further example without limitation, the control instructions may control the introducing of alloy constituents in an alloy extrusion process.

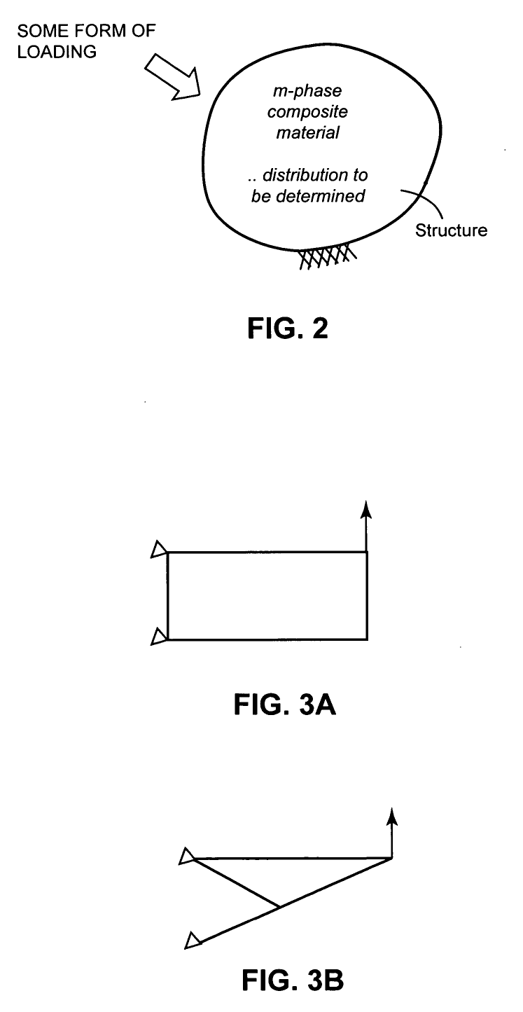

By way of non-limiting example, the discussion below makes reference to a topology optimization problem as conceptualized in FIG. 2 in connection with an example of a two-phase material, i.e., a composite including fibers and epoxy. Generally, each phase of the two-phase material in FIG. 2 is a known material. If the phases include only solid and void, then the “topology problem” is to determine the distribution of the solid material. Topology optimization deals with optimum distribution of material in a given domain. One factor in such optimization is to design the material distribution taking into account a general set of attributes relating to cost, weight, performance criteria, and manufacturing specifications.

As an example, one typical problem is to design a structure for minimum compliance with given amount of material. Minimizing compliance is akin to maximizing stiffness. While the following description is provided in terms of mechanical stiffness, this is merely by way of example. The described techniques and methodology are equally applicable to electrical, magnetic, thermal, optical, fluid and acoustical designs and combinations thereof and are scalable to macro-, micro- and nano-applications.

FIG. 3(a) shows an example structure. This problem of minimizing compliance takes the following form (discussed in greater detail below):
minimize compliance≡ƒ(x) (1)
subject to weight (x)≦w₀ (2)
and 0≦x≦1 (3)
where x represents the set of parameters that the designer needs to compute. FIG. 3(b) shows an example possible optimum topology.

Looking at the compliance minimization problem in equations (1)-(3), it is apparent that it is necessary to express compliance and weight as functions of a design variable vector x, where x=[x₁, x₂, . . . , xₙ]^{T}, wherein n equals the number of design variables. In simple terms, when a particular xᵢ=0, the material in a certain region vanishes, or when xᵢ=1, the corresponding region is dense (solid). Weight is defined as:

$$w = {\sum }_{j} {ρ}_{j} {c}_{j} \qquad ( 4 )$$

where ρⱼ is the homogenized density or density of the “macroscopic” bulk material, cⱼ is a constant, and j is summed to cover the entire domain.

It is convenient to express density ρⱼ as a function of x or
ρⱼ=ρⱼ(x) (5)
to reflect the fact that the density varies as material is re-distributed. Equation (5) denotes “parametrization”—that is, to express density in terms of a finite number of parameters.

Consider the compliance function in Equations (1)-(3) defined by the product of force and displacement as
ƒ=F^{T}U (6)
where U is the displacement vector, obtained by solving finite element equilibrium equations
K U=F (7)
where K is the stiffness matrix for the structure. It will be appreciated K may have different meanings depending on the design consideration. By way of example, for a thermal design consideration, K may be a thermal conductivity matrix for the structure. By way of further example, for an electromagnetic design consideration, K may be a reluctivity matrix for the structure.

Stiffness K is dependent on material properties of the bulk material, such as Young's modulus E, Poisson's ratio v, etc. Again, material re-distribution must reflect changes in these properties. Thus, E, v, etc. must be parametrized as:
E=E(x), v=v(x), . . . (8)

After parametrization as discussed above, a “nonlinear programming” problem of the following form is obtained:
minimize f(x)
subject to gᵢ(x)≦0, i=1, . . . , m
and x^{L}≦x≦x^{U} (9)
where gᵢ are constraints and x^{L} and x^{U} are design variable lower and upper limits, respectively.

Using either gradient or non-gradient optimizers as described in Belegundu et al., Optimization Concepts and Applications in Engineering, Prentice-Hall, 1999 and Belegundu et al., “Parallel Line Search in Method of Feasible Directions”, Optimization and Engineering, vol. 5, no. 3, pp. 379-388, September 2004, the contents of each of which are incorporated herein in their entirety, an optimum topology denoted by x* can be obtained. In the case when there is only a single constraint or m=1, such as a mass restriction in Equations (1)-(3), optimality criteria methods have proved to be efficient.

After solving equation (9), density contours, i.e. contours of ρ(x*), provide a topological form for the structure. Penalty functions can be introduced into equation (9) above to aid in reducing “grey” or “in-between” phases to visualize a sharper outline of the structural form as
ƒf→ƒ+rP (10)
where P(x) is a penalty function and r is a penalty parameter.

These ideas can be easily extended into other engineering areas. For example, in a multiphysics design scenario, it may be necessary to find material properties in a domain, so that (a) heat conduction is minimal and the material is both light and strong, or (b) heat conduction is good and the fatigue life is long, etc.

Existing methods of parametrization include a homogenization theory approach. Topology optimization was initiated with homogenization theory in 1988. See, Bendsoe et al., “Generating Optimal Topologies in Structural Design Using a Homogenization Method”, Computer Methods in Applied Mechanics and Engineering, 71, pp. 197-224 (1988), the contents of which are incorporated herein in their entirety. Further details are available in Eschenauer et al., “Topology Optimization of Continuum Structures: A Review”, Appl Mech Rev, 54(4), pp. 331-390 (2001) and Bendsoe et al., Topology Optimization: Theory, Methods and Applications, Springer, Berlin (2003), the contents of each of which are incorporated herein in their entirety.

In this approach, first, a repeating microstructure is assumed. If the goal is to design a material that has only two phases with one solid and the other void, then a microstructure may be defined by a unit cell with a void. The void can be of any shape such as, but not limited to, a rectangle or a circle.

Homogenization theory suffers from two drawbacks. First, its mathematical complexity is formidable. This has led to a less powerful yet easier parametrization approach as discussed below. Second, thus far, properties relating to the elastic constitutive behavior of the material such as Young's or shear moduli, dielectric constant, and thermal conductivity have been homogenized. See, e.g., Sigmund et al., “Composites with Extermal Thermal Expansion Coefficients”, Applied Physical Letters, 69(21), November 1996. Strength-related properties such as yield strength, fracture strength, hardness, etc. have not been considered. This is also due to the limitations of homogenization theory: (i) mathematical complexity, and (ii) limitations of the central assumption that the unit cell in the repeated microstructure governs properties of the continuum.

A second approach is an artificial parametrization called “SIMP” (Solid Isotropic Material with Penalization). See Bendsoe, Topology Optimization. “Artificial” refers to the fact that no underlying microstructure is assumed. Instead, a parametrization as E(x)=E₀x^{r} is directly adopted, where x is the solid volume fraction. Typically, r=3. The idea here is that a cubic parametrization will tend to drive the design to the final state of xⱼ=0 or xⱼ=1. Although based on an artificial model, the approach is effective on single phase, solid-void topology optimization.

However, the SIMP approach does not provide parametrization of strength properties simultaneously in any meaningful way. Further, there is difficulty in handling three or more phases simultaneously.

The systems and methods of this application perform parametrization based on virtual testing. As with the homogenization theory approach, an underlying microstructure is assumed. The essential difference is in the technique used for parametrization of the homogenized properties of the macroscopic or bulk material. The virtual testing approach leads to two distinct advantages over homogenization and SIMP methodologies. First, it is much easier to obtain the parametrization form. Second, in addition to material properties that enter into the constitutive equations such as moduli, dielectric constant, conductivities, etc., strength-related material properties such as yield strength, ultimate strength, fracture toughness, hardness can just as easily be parametrized.

The virtual testing approach is based on an observation that actual laboratory tests have been developed to determine each material property, which are then published in various handbooks and databases. By mimicking each actual test on the computer via finite element (e.g., classical or inverse) or other numerical simulations, a corresponding “virtual test” can therefore be developed for these multi-phase microstructure systems.

For example, a virtual tensile test will provide Young's modulus E, yield strength σ_{y}, and ultimate strength σᵤ. Other tests will provide shear modulus, dielectric constant, hardness etc. Repeating such tests for different microstructure sizes/shapes (parametrized by xᵢ) will yield the required parametrization or functional relationships as E(x), σ_{y}(x), G₁₂(x), etc.

To illustrate the virtual testing approach, consider a repeating microstructure including a square void within a unit cell. The homogenized or bulk properties will be those of an orthotropic material with three independent constants, viz. E, v, and G₁₂. Of course, while this example involves an orthotropic material, the virtual testing approach is also applicable to materials that are isotropic, anisotropic, transversely isotropic, etc. E₀, v₀, and G₁₂₀ are denoted as the properties of the non-void material, and E/E₀, v/v₀, and G₁₂ / G₁₂₀ as the ‘normalized’ values. Also, letting x be the volume fraction of solid material, the normalized material constants can be seen to vary from 0 to 1 as x varies from 0 to 1, respectively.

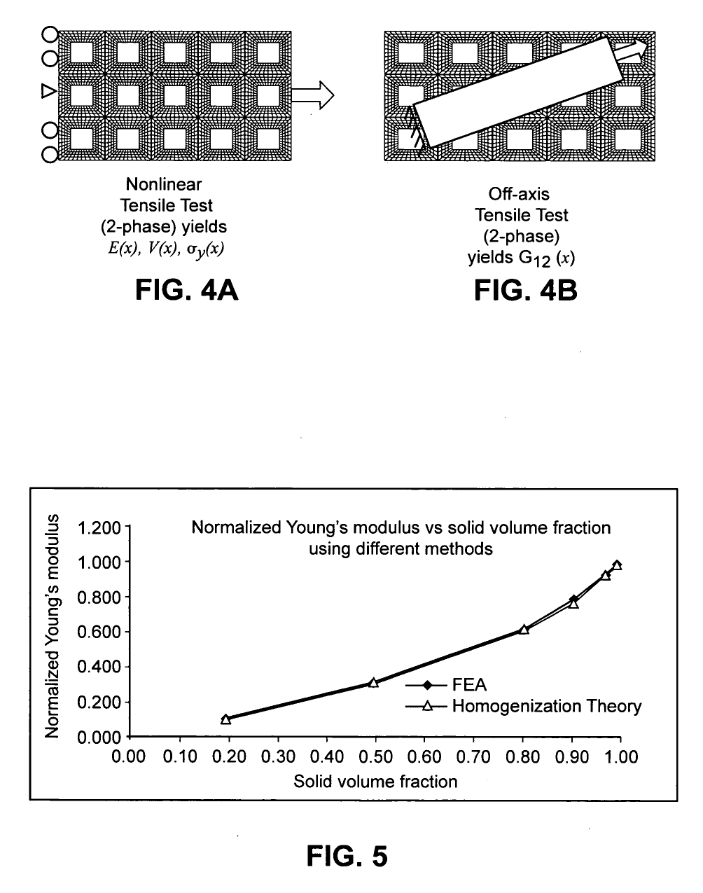

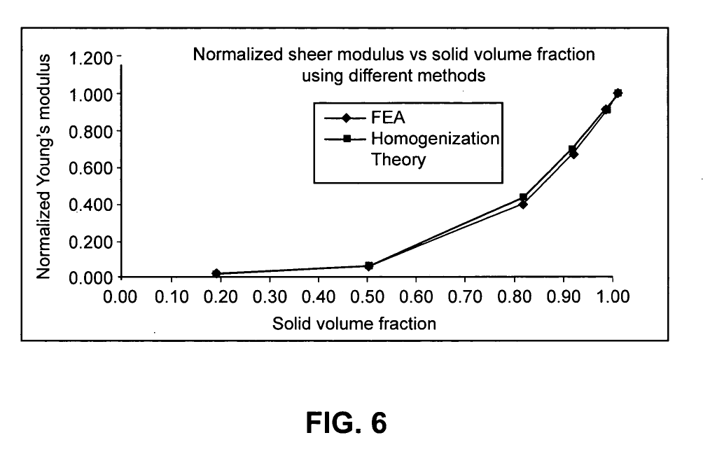

FIGS. 4(a) and 4(b) show two virtual finite element analyses (FEA) models. The FIG. 4(a) model is for a non-linear tensile strength test which yields E(x), v(x) and σ_{y}(x). The FIG. 4(b) model yields G₁₂(x) from the well-known equation

$$\frac{1}{{G}_{12}} = \frac{1}{{sin}^{2} θ {cos}^{2} θ} ( \frac{1}{{\overline{E}}_{1}} \cdot \frac{{cos}^{4} θ}{{E}_{1}} - \frac{{sin}^{4} θ}{{E}_{2}} + \frac{2 {ν}_{12}}{{E}_{1}} {sin}^{2} θ {cos}^{2} θ )$$

The virtual testing approach agrees well with homogenization theory as seen in FIG. 5. The virtual tests are insensitive with respect to number of unit cells considered or the finite element mesh.

The virtual testing approach provides numerous advantages. For example, hitherto, strength properties have not been homogenized or parametrized in any clear way. A consequence of this is that only global response has been incorporated into an optimization problem such as involving displacement. Local responses such as involving stress have not been tackled. The ability to parametrize strength properties using the virtual testing approach as described above allows general design problems to be tackled, hitherto untenable. This follows from the equations (11) below:

$$\begin{matrix}displacement based on ≦ specified displacement limit \\ hmomgenized material constants \\ stress based on homogenized ≦ strength obtained from \\ material constants virtual tensile test \\ constaints based on fatigue , fracture , hardness \\ composite ply failures , etc .\end{matrix}$$

This is a consistent homogenization approach for both stress and strength quantities. Constraint in (11), denoted by g≦0 is implemented in finite element i as

$$\sqrt{g + 1} ≦ 1 + \frac{\sqrt{{x}^{L} ( i )}}{x ( i )} \qquad ( 12 )$$

to overcome a singularity. This ensures that the stress constraint is not active where there is no material.

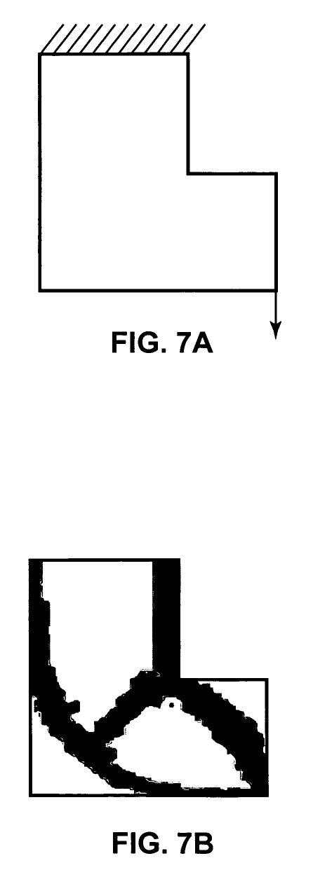

Further, multiobjective (i.e., multiattribute) optimization problems can be formulated and solved as discussed in Grissom et al., Conjoint Analysis Based Multiattribute Optimization, Journal of Structural Optimization (2005), the contents of which are incorporated herein. An example problem involving topology optimization with von Mises yield stress and displacement constraints is shown in FIGS. 7A and 7B.

Example virtual tests for axial and transverse thermal conductivity of a unidirectional graphite/epoxy composite will now be discussed. The same finite element model used for mechanical property estimation can also be used for finding the thermal properties of composite materials. The axial and transverse conductivities can be calculated using Fourier's Law in equation 13 below. By obtaining the unidirectional flux Q from the finite element model to which a temperature gradient is applied in the direction in which the conductivity K is to be calculated, the following equation results:

$$K = \frac{Q}{Δ T / Δ x} \qquad ( 13 )$$

where ΔT is the temperature change and Δx is the length (distance) through which this temperature change occurs.

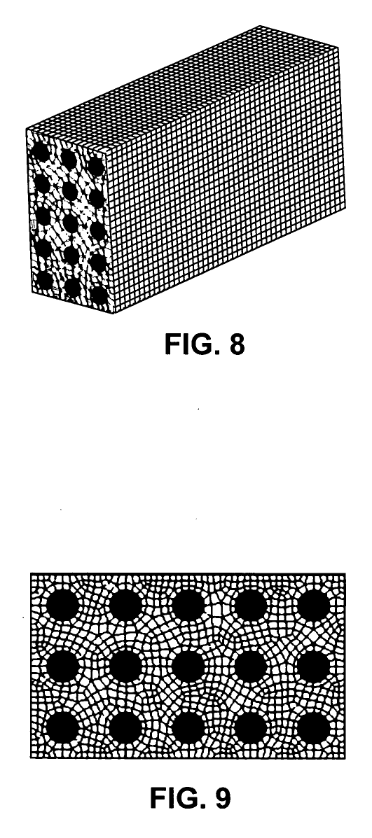

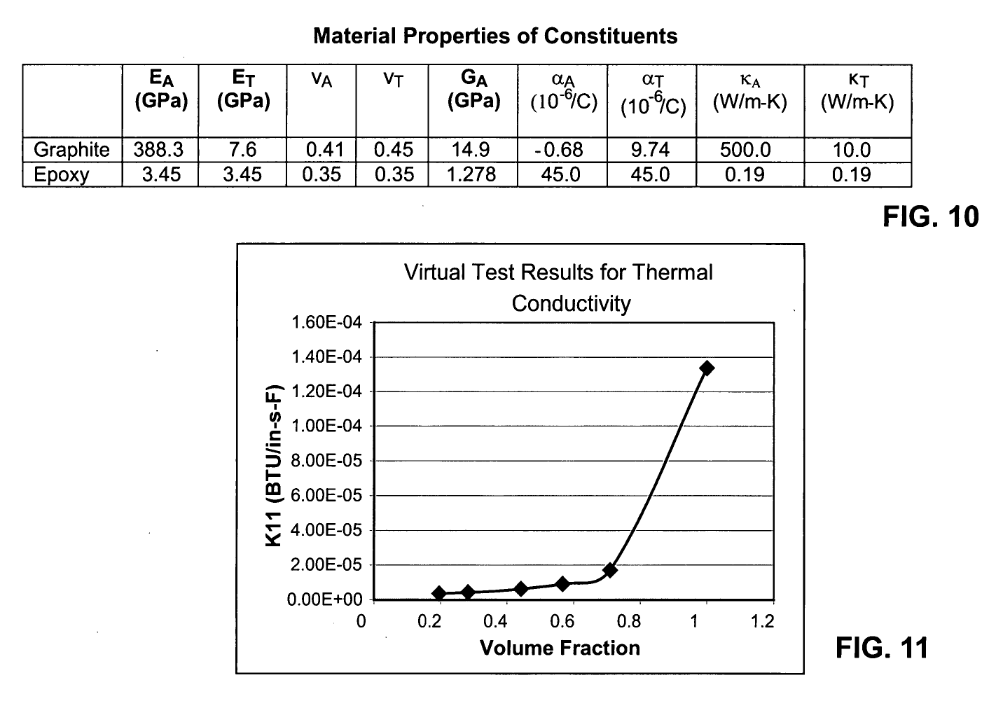

FIGS. 8 and 9 are used for obtaining axial and transverse thermal conductivities. FIG. 8 shows an example 3D finite element mesh for computing axial properties and FIG. 9 shows an example 2D finite element mesh for computing transverse properties. Unidirectional heat flow is simulated by applying homogeneous Neumann boundary conditions for heat flux on the remaining faces/edges. FIG. 10 shows the material properties of the constituents and FIG. 11 shows virtual test results for thermal conductivity for different volume fractions. Specifically, FIG. 11 shows axial thermal conductivity versus volume fraction for the graphite/epoxy composite.

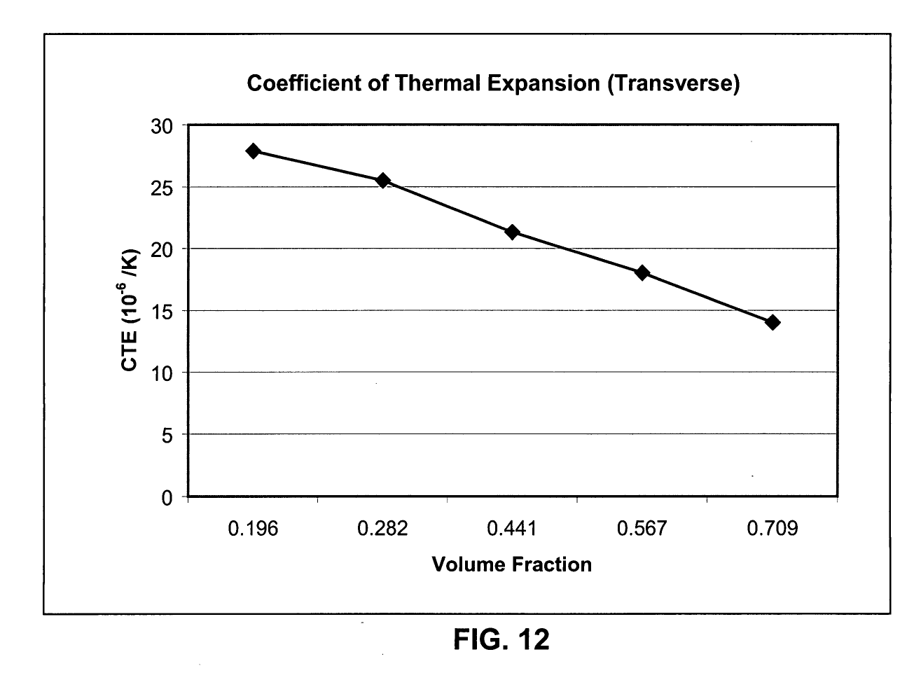

This same procedure can also be used for obtaining other thermal properties such as coefficient of thermal expansion (CTE) and the like. A sample set of CTE values are shown in FIG. 12. Specifically, FIG. 12 shows transverse CTE values versus volume fraction for the graphite/epoxy composite.

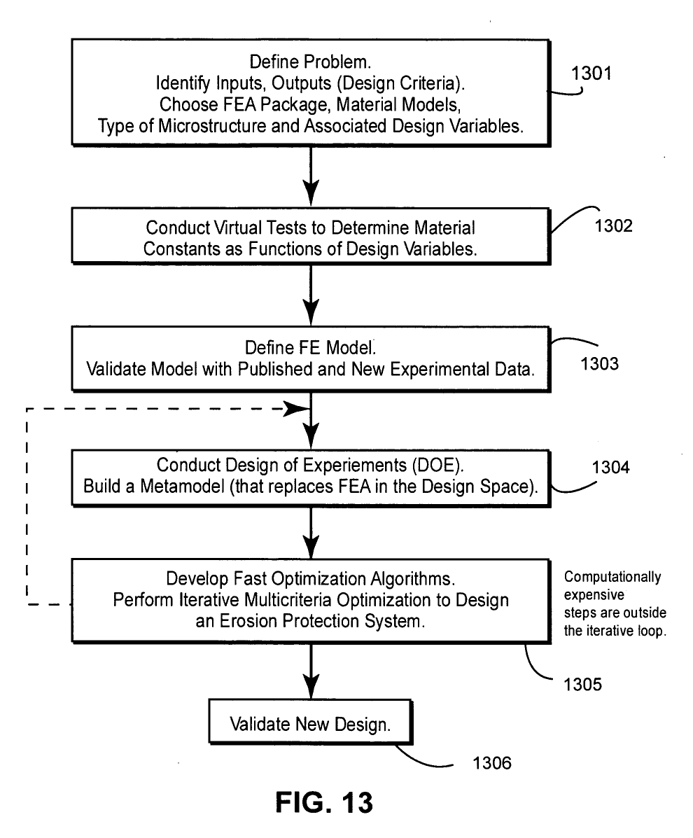

FIG. 13 shows a flow diagram for another example process in which virtual testing may be used. At step 1301, the problem is defined along with identifying inputs and outputs (design criteria), choosing a finite element analysis package, material models, type(s) of microstructure and associated design variables. At step 1302, virtual testing is conducted to determine material constants as functions of design variables and, at step 1303, a finite element model is defined. This model can be validated with published and new experimental data. At step 1304, design of experiments (DOE) are conducted and a metamodel is built that replaces the finite element analysis model in the design space. At step 1305, optimization algorithms are used to optimize the design and the new design is validated at step 1306. Steps 1304 and 1305 may be performed in an iterative loop.

Advantages of the virtual testing approach include:
Virtual testing approach is significantly less formidable, mathematically, than the existing homogenization theory approach. Consequently, it is likely to be adopted more widely in the optimization community.
Virtual testing can be used to parametrize strength related properties in addition to the moduli related properties considered to-date. This includes yielding, fracture, fatigue, hardness, etc.
By parametrizing a more general set of material properties (thermal, electrical, acoustic etc.), more general optimization problems can be posed and solved in the context of multi-physics topology optimization. Thus, the initial topology will be more economical prior to obtaining a more detailed design.
Parametrization through real testing is not precluded.
Through either virtual or real testing, difficult properties such as corrosion resistance can also be modeled.
Proposed optimal design methodology allows solution of more real world design problems involving single or multi-physics scenarios, and the traditional sizing, shape and topology design optimization.
Solution sets can be derived in various forms such as orthotropic, isotropic, anisotropic, transversely isotropic, etc.
Results can be used for control systems for manufacturing machinery and apparatus used in volumetrically controlled manufacturing to provide, for example, for proper sequencing of raw materials in the manufacturing process (e.g., the introducing of alloy constituents in an alloy extrusion process).

Generally speaking, the techniques described herein may be implemented in hardware, firmware, software and combinations thereof. The software or firmware may be encoded on a storage medium (e.g., an optical, semiconductor, and/or magnetic memory) as executable instructions that are executable by a general-purpose, specific-purpose or distributed computing device including a processing system such as one or more processors (e.g., parallel processors), microprocessors, micro-computers, microcontrollers and/or combinations thereof. The software may, for example, be stored on a storage medium (optical, magnetic, semiconductor or combinations thereof) and loaded into a RAM for execution by the processing system. Further, a carrier wave may be modulated by a signal representing the corresponding software and an obtained modulated wave may be transmitted, so that an apparatus that receives the modulated wave may demodulate the modulated wave to restore the corresponding program. The systems and methods described herein may also be implemented in part or whole by hardware such as application specific integrated circuits (ASICs), field programmable gate arrays (FPGAs), logic circuits and the like.

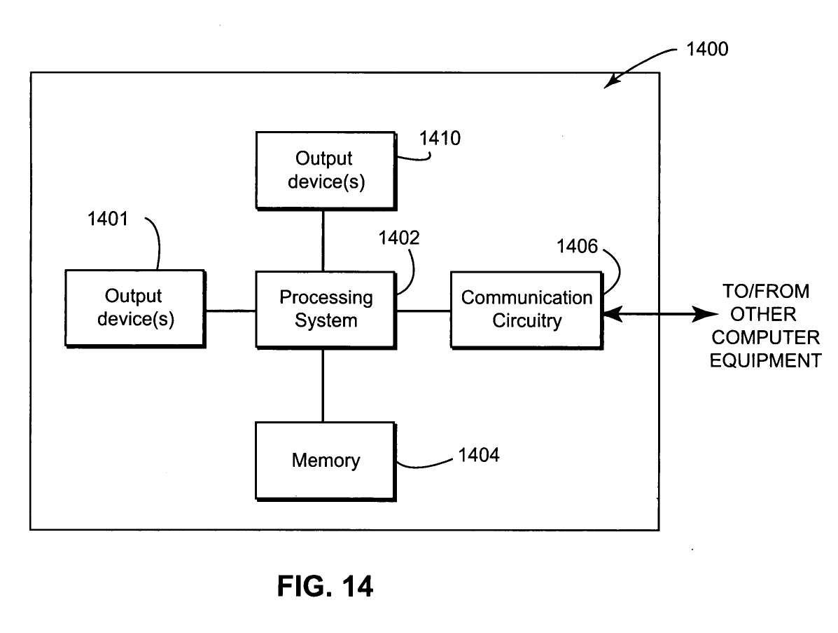

FIG. 14 is a generalized block diagram of computing equipment on which applications, modules, functions, etc. described in this application may be executed. Computing equipment 1400 includes a processing system 1402 which as noted above may include one or more processors (e.g., parallel processors), microprocessors, micro-computers, microcontrollers and/or combinations thereof. Memory 1404 may be a combination of read-only and read/write memory. For example, memory 1404 may include RAM into which applications, modules, functions, etc. are loaded for execution by processing system 1402. Memory 1404 may include non-volatile memory (e.g., EEPROM or magnetic hard disk(s)) for storing the applications, modules, functions and associated data and parameters. Communication circuitry 1406 allows wired or wireless communication with other computing equipment over local or wide area networks (e.g., the internet), for example. Various input devices 1408 such as keyboard(s), mice, etc. allow user input to the computing equipment and various output devices 1410 such as display(s), speaker(s), printer(s) and the like provide outputs to the user.

While the above description is provided in connection with what is presently considered to be the most practical and preferred embodiment, it is to be understood that the systems and methods described herein are not to be limited to the disclosed embodiment, but on the contrary, are intended to cover various modifications and equivalent arrangements included within the spirit and scope of the appended claims.

We claim:

1. A method of generating a topology for a material, the method comprising:
parametrizing one or more material properties of the material using virtual testing; and
generating a topology for the material based on the parametrizing.

2. The method according to claim 1, wherein the material is a multi-phase material.

3. The method according to claim 1, wherein the multi-phase material comprises a solid phase and a void phase.

4. The method according to claim 1, wherein the parametrized material properties include mechanical material properties.

5. The method according to claim 1, wherein the parametrized material properties include electrical material properties.

6. The method according to claim 1, wherein the parametrized material properties include acoustic material properties.

7. The method according to claim 1, wherein the parametrized material properties include thermal material properties.

8. The method according to claim 1, wherein the parametrized material properties include optical material properties.

9. A computer-readable medium having computer readable code embodied therein for use in the execution by a processing system of a method of generating a topology for a material, the method comprising:
parametrizing one or more material properties of the material using virtual testing; and
generating a topology for the material based on the parametrizing.

10. A computer program product for use in the execution by a processing system of a method of generating a topology for a material, the computer program product comprising:
a first module for parametrizing one or more material properties of the material using virtual testing; and
a second module for generating a topology for the material based on the parametrizing.

11. A data signal embodied in a carrier wave and representing a sequence of instructions which, when executed by a processing system, cause the processing system to perform a method of generating a topology for a material, the method comprising:
parametrizing one or more material properties of the material using virtual testing; and
generating a topology for the material based on the parametrizing.
